(19) United States
(12) Patent Application Publication
(10) Pub. No.: US 2008/0238874 A1
(43) Pub. Date: Oct. 2, 2008

(54) Operation device

(75) Inventors: Norio Yamamoto, Kariya-city (JP); Nozomi Kitagawa, Okazaki-city (JP); Hiroaki Sasaki, Chiryu-city (JP); Takeshi Haruyama, Kariya-city (JP); Motohiro Fukumoto, Nagoya-city (JP); Hirotake Sano, Nishikamo-gun (JP); Haruyuki Kodera, Toyota-shi (JP); Kenji Mori, Nagoya-shi (JP); Kazuhiro Kawachi, Nishikamo-gun (JP)

Correspondence Address: POSZ LAW GROUP, PLC, 12040 SOUTH LAKES DRIVE, SUITE 101, RESTON, VA, 20191, US

(73) Assignees: DENSO CORPORATION, Kariya-city (JP); TOYOTA JIDOSHA KABUSHIKI KAISHA, Toyota-city (JP)

(21) Appl. No.: 12/076,973

(22) Filed: Mar. 26, 2008

(30) Foreign Application Priority Data
Mar. 28, 2007 (JP) 2007-84583

(51) Int. Cl. G06F 3/033

(52) U.S. Cl. 345/163

(57) ABSTRACT

A display device is provided in a central position of an instrument panel in a vehicle compartment, and an operation device is provided in a center console. The operation device is formed with a case body having a palm rest, with is provided with a pointing device and four finalizing switches. A menu display window showing an array of multiple function selection items or a list display screen is displayed on a screen of the display device. The user selects a desired function selection item by moving a cursor by operation of an operation knob of the pointing device. In this state, the user ON operates any one of the finalizing switches, thereby performing finalize-designation. A user can thus operate the operation device from any one of multiple directions without uncomfortable feeling.

### CROSS REFERENCE TO RELATED APPLICATION

This application is based on and incorporates herein by reference Japanese Patent Application No. 2007-84583 filed on Mar. 28, 2007.

### FIELD OF THE INVENTION

The present invention relates to an operation device for selecting a function displayed on a screen of a display device and performing the selected function.

### BACKGROUND OF THE INVENTION

As this type of operation device, a mouse-shaped input device (hereinbelow, simply referred to as a “mouse”) used as a pointing device to specify a position on a screen of a personal computer or the like is known (for example, see Patent Document 1). This mouse has a mechanism to detect direction and amount of its moving (for example, an optical sensor) in its main body case, and has left and right press button switches.

A user moves the main body case thereby freely moves a cursor in XY-direction in a screen of a display device, to point a desired icon (command or the like). In this state, the user press-operates (i.e., operates by pressing) a left side button with an index finger (left click), thereby finalizing selection of the pointed icon. Further, at this time, a function other than the operation of the left side button is realized by operation of a right side button provided on the mouse with a middle finger (right click). Note that generally, this mouse is appropriate to operation with the user's right hand when it is placed on the right side of the user facing the personal computer (display device).

Patent Document 1: JP-2003-131806 A

In recent years, in a vehicle such as an automobile, a system for integrated operations with respect to multiple in-vehicle devices such as a car navigation system, a car audio system, and a car air conditioner is provided. The system has a display device in a central position of an instrument panel and an operation device (remote operation device) in a center console.

In these systems, a rotary dial which is turnable and pressable is employed. The rotary dial is turned; thereby, a pointing operation (selection of an item in a display screen) is performed. Then the rotary dial is pressed; thereby finalization is performed. Further, as the operation device is provided in the center console, it can be operated from both driver and fellow passenger. However, as these systems employ the rotary dial for pointing operation, it takes time in character input operation or the like using e.g. a list of 50-character kana syllabary.

The inventors have designed a structure having a joystick-type operation device in which a selection operation is performed by tilting an operation knob in place of the above-described rotary dial. However, upon tilting operation and pressing operation, when the pressing operation is performed while the operation knob is tilted at a wide angle, a pointing position is often shifted. That is, the operability is lowered. Accordingly, a finalizing switch such as a press button may be provided in a position different from the operation knob (shaft) of the joy stick.

However, when such finalizing switch is provided, the position of the switch is a problem. For example, in a right-hand drive (Japanese) vehicle, a driver operates the operation device with his/her left hand. When the finalizing switch is provided in a position for easiness of operation with the driver's left thumb, it is difficult for a fellow passenger on a passenger seat to operate the operation device with his/her right hand. That is, in applications of the joystick-type operation device to a vehicle, an operation device which can be easily operated from both driver's seat (driver) and passenger's seat (fellow passenger) without uncomfortable feeling is desired.

Note that the position of the finalizing switch with high operability differs in accordance with size of user's hand and way of holding the knob. Further, in the above-described mouse type operation device, a device with high operability for left-handed users as well as right-handed users, i.e., a device which can be operated with a left hand without uncomfortable feeling is desired.

### SUMMARY OF THE INVENTION

The present invention has been made in view of the above situation, and it is an object of the present invention to provide an operation device for selecting a function displayed on a screen of a display device and performing the selected function, with excellent operability, which can be operated without uncomfortable feeling in operation from any direction.

According to an example of the present invention, an operation device for selecting a function displayed on a screen of a display device and performing the selected function is provided as follows. A case body, a function selection switch, and at least two finalizing switches are included. The function selection switch is provided on the case body for selecting a function selection item displayed on the screen. The at least two finalizing switches are provided in the case body for finalize-designating the function selection item selected with the function selection switch. Herein, a same finalize-designation is made at a same timing by operating any of the at least two determination switches.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram schematically showing an electrical configuration of an in-vehicle device operation system according to an embodiment of the present invention;

FIG. 2 is a plan view of an operation device;

FIG. 3 is a perspective view of the operation device;

FIG. 4 is a perspective view showing the inside of a vehicle compartment;

FIG. 5A is an example of a menu display window; and

FIG. 5B is an example of a list display window.

### DETAILED DESCRIPTION OF THE PREFERRED EMBODIMENTS

Hereinbelow, an embodiment in which the present invention is applied to an in-vehicle operation device will be described based on the drawings. Note that the present embodiment shows an operation system for integrated input and instruction operations (remote operations) with respect to a car navigation system, a car audio system, and a car air conditioner as in-vehicle devices. Further, in the present embodiment, the vehicle is a so-called right-hand drive (Japanese) vehicle; however, the present invention is also applicable to a left-hand drive vehicle.

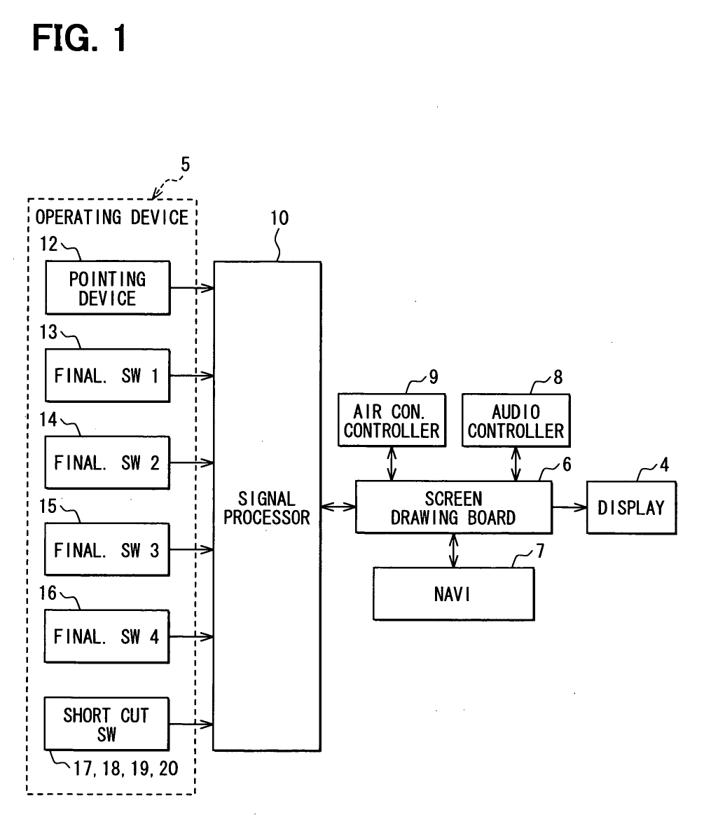

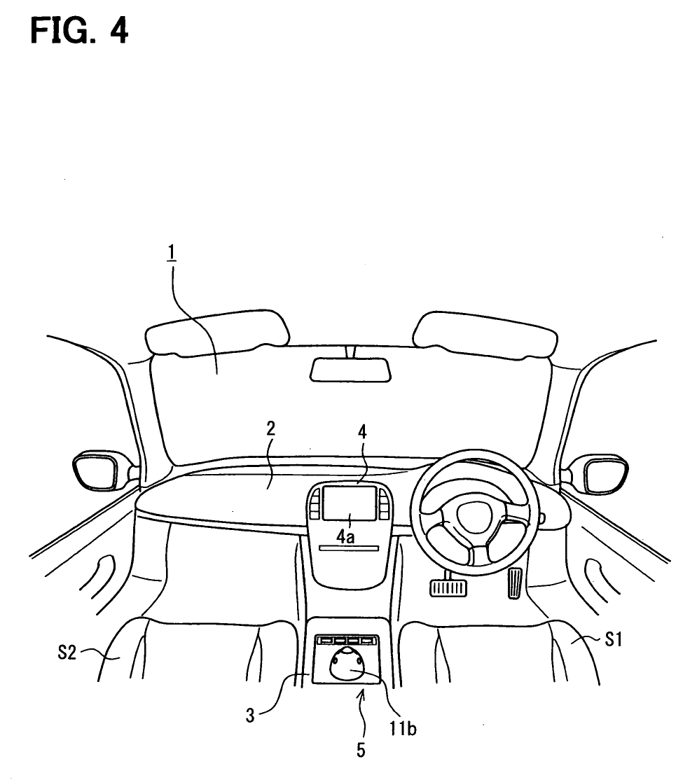

FIG. 4 schematically shows a front part of a vehicle compartment 1 of the vehicle (right-hand drive Japanese vehicle). FIG. 1 schematically shows an electrical configuration of the in-vehicle device operation system according to the present embodiment. As shown in FIG. 4, in the vehicle compartment 1, a driver's seat S1 and a fellow passenger's seat S2 are adjacently provided. An instrument panel 2 is provided in front of the seats, and a center console 3 is provided so as to extend from a lower central position of the instrument panel 2 into the space between the driver's seat S1 and the fellow passenger's seat S2.

As shown in FIG. 4, a display device 4 is provided at the center of the instrument panel 2. Further, as described in detail later, an operation device 5 according to the present embodiment is provided in the center console 3 in a position around a shift lever (not shown). The operation device 5 is provided in a position appropriate for operation by the driver on the driver's seat with his/her left hand (a position in which the driver does not fully stretch his/her hand and can easily operate the operation device), and a position in which the fellow passenger on the fellow passenger's seat can easily operate the device with his/her right hand.

The display device 4, which is, for instance, a full-color liquid crystal display, is provided with a touch sensitive panel (not shown) on a surface of its display screen 4a. As shown in FIG. 1, a display on the screen 4a of the display device 4 is controlled by a screen drawing board 6 (see FIG. 1). The screen drawing board 6 is connected with a car navigation system 7, an audio controller 8 to control the car audio system, an air conditioner controller 9 to control the car air conditioner, and a signal processor 10 to be described later. Note that in the present embodiment, the car audio system includes a radio and a TV set.

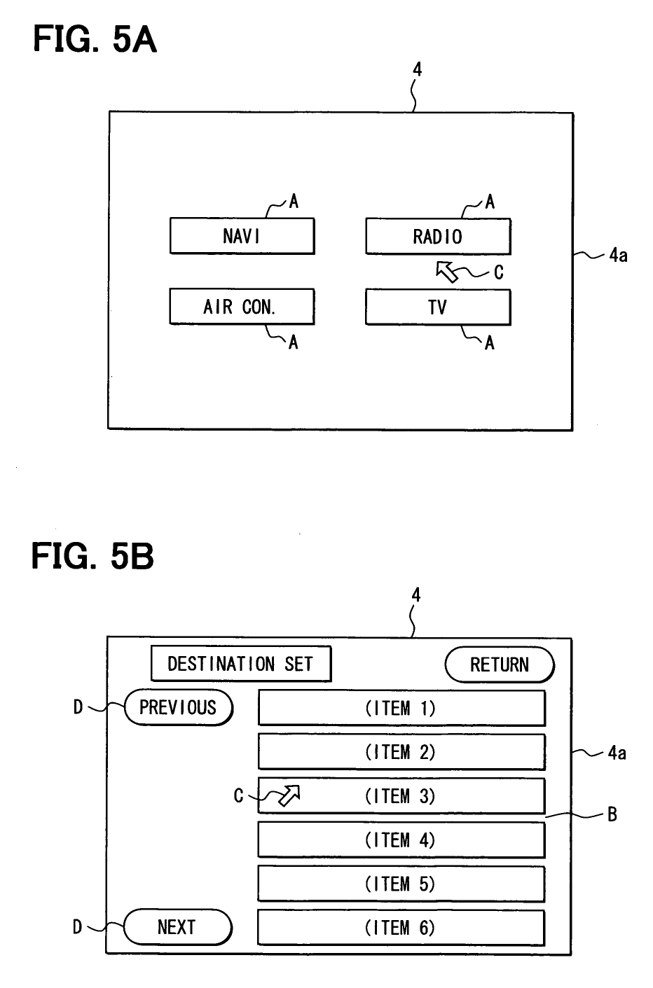

On the screen 4a of the display device 4, a navigation screen (a screen in which a current location and driving direction of the vehicle are superimposed on a peripheral road map) is displayed, or a TV screen is displayed by the audio controller 8, otherwise, as described later, a selection screen (see FIG. 5) for a user's various instruction inputs/settings is displayed, or various messages and the like are displayed.

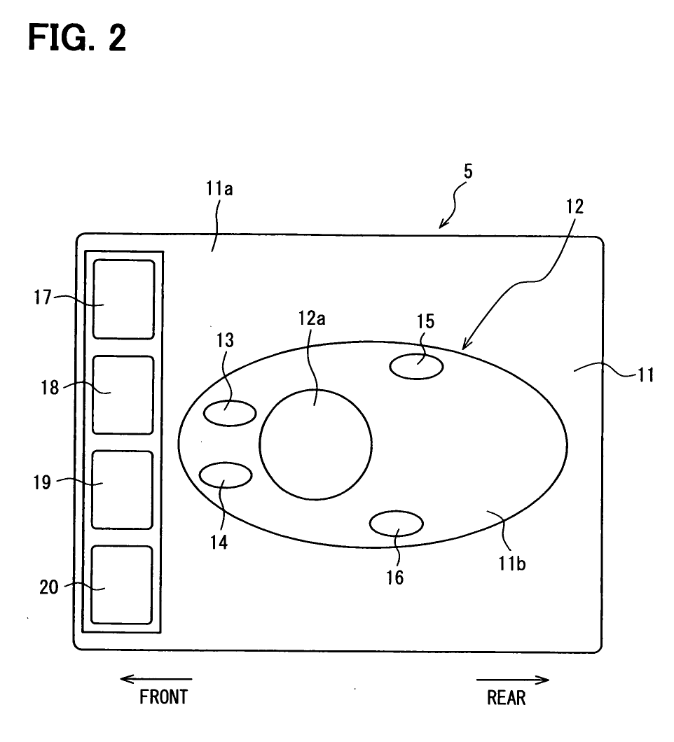

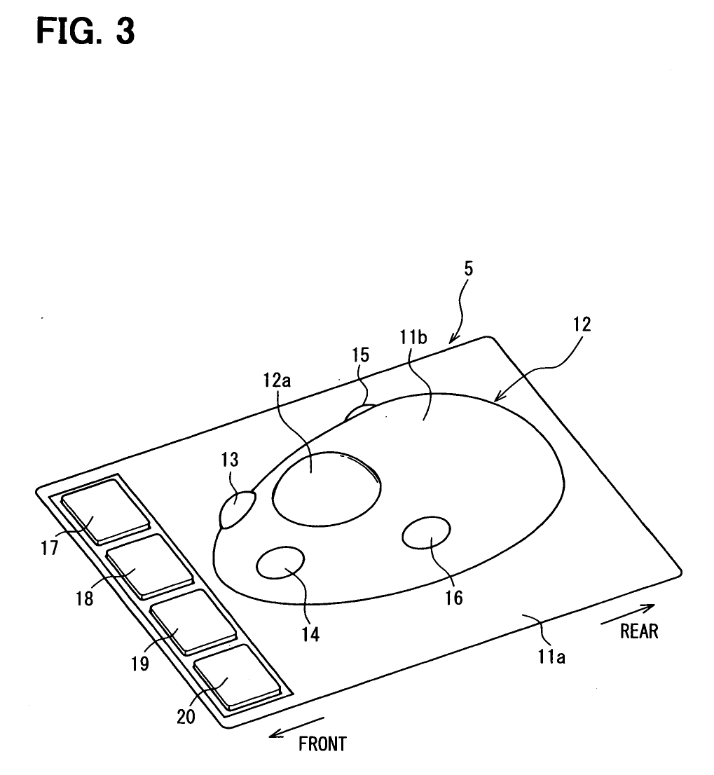

Next, the operation device 5 will be described with reference to FIGS. 2 and 3. The operation device 5 has a case body 11 of e.g. plastic, a pointing device 12 provided on the case body 11 (see FIG. 1) as a function selection switch to select a function selection item, and two or more (four in the present embodiment) finalizing switches 13 to 16 provided on the case body 11 for finalize-designation (i.e., designation for finalizing).

The case body 11 has a base 11a which is a rectangular flat plate, attached to an upper surface of the center console 3, and a palm rest 11b, having a round raise from the upper surface of the base 11a, as a long elliptical shape in a longitudinal direction (like an upper half of an egg placed with its longer diameter along a horizontal direction), integrated with each other. In this case, the palm rest 11b has a palm rest function for stably fixing the user's hand when the hand is placed on the case body. Regardless of the driver's left hand from the driver's seat or the fellow passenger's right hand from the fellow passenger's seat, the hand is stably fixed.

The pointing device 12 has e.g. a joy stick mechanism. An operation knob 12a, having a semispherical shape, for example, is provided in a front central position of an upper surface of the palm rest 11b. In this case, the operation knob 12a is provided in a position in which the user (the driver or the fellow passenger), who places his/her hand on the palm rest 11b to thereby fix the hand, can operate the knob using his/her index finger and/or middle finger similarly from one of both sides. The operation knob 12a is provided rotatably (tiltably) at 360 degrees about a vertical axis. The pointing device 12 outputs a signal corresponding to an operation direction and an operation amount of the operation knob 12a to the signal processor 10.

The signal processor 10 moves a cursor C (see FIG. 5) on the screen 4a of the display device 4 in correspondence with the signal from the pointing device 12. As described later, in a status where a selection screen having an array of multiple function selection items (keys with characters and icons) is displayed on the screen 4a of the display device 4, the user can select a function selection item by operating the pointing device 12.

The four finalizing switches 13 to 16, which are press button switches each having e.g. a tact switch on the lower surface side, are provided in different positions on the surface of the palm rest 11b around the operation knob 12a. More particularly, a first finalizing switch 13 and a second finalizing switch 14 are symmetrically provided in front right and left positions with respect to the operation knob 12a; and a third finalizing switch 15 and a fourth finalizing switch 16, symmetrically provided in rear right and left positions with respect to the operation knob 12a.

In this case, the first finalizing switch 13 is provided in a position appropriate for a press operation with the diver's index finger when his/her left hand is placed on the palm rest 11b. The third finalizing switch 15 is provided in a position appropriate for an operation with the driver's thumb. On the other hand, the second finalizing switch 14 is provided in a position appropriate for a press operation with the fellow passenger's index finger when his/her right hand is placed on the palm rest 11b. The fourth finalizing switch 16 is provided in a position appropriate for an operation with the fellow passenger's thumb.

These four finalizing switches 13 to 16 fulfill the function of finalize-designation of a function selection item selected with the pointing device 12. Operation signals from the first to fourth finalizing switches 13 to 16 are inputted into the signal processor 10. At this time, the same designation can be made at the same timing in accordance with operation of any of these four finalizing switches 13 to 16. Further, in the present embodiment, the four finalizing switches 13 to 16 always fulfill the same function (finalize-designation function) regardless of running or stopped status of the vehicle.

Further, in the present embodiment, the operation device 15 is provided with four short cut switches 17 to 20 to directly designate execution of functions, along a front end of the base 11a of the case body 11. These four short cut switches 17 to 20, which are press button switches, are provided to directly execute the respective functions without the user's selection operation in a menu display window or the like to be described later.

In this case, for example, the short cut switches 17 to 20 fulfill the functions of navigation screen display, destination setting, car air conditioner ON (OFF), and car audio system ON (OFF). Signals from the short cut switches 17 to 20 are also inputted into the signal processor 10.

The signal processor 10, having a microcomputer and the like, inputs operation signals corresponding to an operation content of the operation device 5 (a signal indicating the operation direction and operation amount of the pointing device 12, an operation signal from the finalizing switches 13 to 16, an operation signal from the short cut switches 17 to 20). The signal processor 10 causes the screen drawing board 6 to perform drawing processing of the screen 4a of the display device 4, and supplies signals via the screen drawing board 6 to the car navigation system 7, the audio controller 8, and the air conditioner controller 9 to perform the respective functions, in accordance with the input signals.

At this time, the signal processor 10 displays a menu display window (see FIG. 5A) on the screen 4a of the display device 4 via the screen drawing board 6 upon power-on, in accordance with its software configuration (program execution). As shown in FIG. 5A, in this menu display window, four function selection items A, “navigation,” “air conditioner,” “radio,” and “TV” are displayed. One of these functions can be selected and performed by operating the operation device 5.

As described above, when the user operates the operation knob 12a of the pointing device 12, the cursor C is moved on the screen 4a in correspondence with the operation via the signal processor 10 and the screen drawing board 6. When the user moves the cursor C to a desired item A, and in this state, the user ON operates (i.e., performs an operation of turning ON) one of the finalizing switches 13 to 16, the signal processor 10 performs the processing (car air conditioner ON, radio ON and the like) corresponding to the selected (selection-finalized) item A.

Further, although the details are not shown, when the user selects the “navigation” processing, and further designates execution of destination search in the next display window, the car navigation system 7 displays a selection display window including multiple selection items (classification by institution or the like) on the screen 4a of the display device 4, for the user's select-designation of classification for search. The car navigation system 7 retrieves (extracts) corresponding destinations based on the user's designation operation. Then, a list display screen including an array of the retrieved destination candidates as selection items is displayed on the screen 4a of the display device 4.

FIG. 5B shows an example of the list display window. In the screen 4a, six selection items B (“ITEM 1” to “ITEM 6”) are arrayed vertically in six rows, and page scroll items D (“NEXT” (i.e., next page) and “PREVIOUS” (previous page) are displayed. The user also operates the knob 12a of the pointing device 12 to thereby move the cursor C to a desired selection item B. In this state, the user ON operates any one of the finalizing switches 13 to 16 to thereby finalize the destination. The car navigation system 7 performs a route search to obtain a recommended route to the destination and route guidance processing for guidance of the route.

The operation device 5 has the above structure, which is different from a case where one operation knob is rotate-operated and tilt-operated. As the finalizing switches 13 to 16 are provided in addition to the pointing device 12 (operation knob 12a) as a function selection switch, the occurrence of operation error is suppressed, and operability for the user can be improved. In this case, as the user's hand when placed on the palm rest 11b provided on the case body 11 is stably fixed, further excellent operability is obtained upon operation of the operation knob 12a and the finalizing switches 13 to 16.

Further, in the present embodiment, the four finalizing switches 13 to 16 are provided on the case body 11, and the same finalize-designation can be made at the same timing in accordance with operation of any of these four finalizing switches 13 to 16. Accordingly, upon finalize-designation, the user operates any appropriate one of the finalizing switches 13 to 16. That is, the finalize-designation convenient for the user can be made. Further, as it is not necessary for the user to check a button to be operated, a smooth operation can be realized.

At this time, as the operation device 5 is provided in the center console 3 between the driver's seat and the fellow passenger's seat, the operation device 5 can be easily operated from any one of the driver's seat and the fellow passenger's seat. Especially, as the four finalizing switches 13 to 16 which can be used for the same finalize-designation at the same timing with respect to the operation knob 12a at the center of the case body 11 (palm rest 11b), are provided in front and rear, and right and left positions of the case body 11, the driver and the fellow passenger can similarly perform an operation with a thumb or index finger without uncomfortable feeling.

Note that to ensure safety of vehicle running, operation of the car navigation system or the like may be prohibited (switch operation may be disabled). However, in such arrangement, a fellow passenger on the fellow passenger's seat cannot operate the car navigation system or the like during vehicle running. However, in the present embodiment, as the finalize-designation operation can be made with the finalizing switches 13 to 16 regardless of running/stopped state of the vehicle (all the finalizing switches 13 to 16 fulfill the same function), other passenger than the driver can safely operate the navigation system or the like during vehicle running.

According to the present embodiment, the operation device 5 for selecting a function displayed on the screen 4a of the display device 4 and performing the selected function is provided with the pointing device 12 as a function selection switch to select a function selection item and the four finalizing switches 13 to 16 to finalize-designate a selected function selection item, and further, the same finalize-designation can be made at the same timing in accordance with any one of the finalizing switches 13 to 16. Accordingly, excellent operability can be obtained, and the user can operate the operating device without uncomfortable feeling from any one of multiple directions.

Note that the present invention is not limited to the above-described embodiment, however, extension and changes as described below can be made. In the above embodiment, a joy stick mechanism is employed as a function selection switch (the pointing device 12), however, other mechanisms such as a track ball (haptic device), an 8-direction (4-direction) switch, a touch tracer, a rotary switch and a slide switch may be used. Further, the shape of the palm rest is not limited to the above-described shape, but various modifications may be used.

Further, in the above embodiment, the four finalizing switches 13 to 16 are provided on the palm rest 11b, however, six or two finalizing switches may be symmetrically provided. When two finalizing switches are provided, press buttons which are long in the longitudinal direction in left and right positions of the function selection switch are effective. Further, in addition to two or more finalizing switches, another switch such as “cancel (return)” switch may be provided. In this case, it is desirable that the other switch is provided in a position different from the positions of the finalizing switches and a position distinctive from the finalizing switches without the user's checking.

In the above-described embodiment, the operation device 5 is used for integrated operations with respect to the car navigation system, the car audio system and the car air conditioner as in-vehicle devices. However, the operation device 5 may also be used for operations with respect to other in-vehicle devices such as an electric mirror, a power window, wiper(s), and lamp(s). Further, the operation device 5 may be used for operations with respect to a single device. Further, the operation device 5 may be provided in, not only on the center console 3 but a position around the display device of the instrument panel.

Further, the application of the present invention is not limited to the operations with respect to in-vehicle devices. For example, the invention is applicable to a so-called mouse type operation device for operation of a personal computer or the like. Further, regarding the display format of function selection items (screen structure), various modifications, such as a menu bar for selection, on the top/bottom/left/right side(s) of the screen, may be used. Further, various modifications can be made within the scope of the subject matter of the present invention.

Aspects of the disclosure described herein are set out in the following clauses.

According to an aspect, an operation device is provided for selecting a function displayed on a screen of a display device and performing the selected function. The operation device includes: a case body; a function selection switch, provided on the case body, for selecting a function selection item displayed on the screen; and two or more finalizing switches, provided in the case body, for finalize-designating the function selection item selected with the function selection switch, wherein the same finalize-designation is made at the same timing by operation with any of the two or more determination switches.

In the above operation device, as the finalizing switches are provided in addition to the function selection switch, the operability can be improved. The same finalize-designation can be performed at the same timing by operation of any one of multiple finalizing switches provided on the case body. Accordingly, a user can operate a finalizing switch convenient for the user from any direction without uncomfortable feeling. Thus user-friendly finalizing operation can be realized.

Further, in the operation device, provided in a vehicle, for performing various functions with respect to in-vehicle devices, the two or more finalizing switches always realize the same function regardless of running or stopped status of the vehicle. In this structure, various functions with respect to the in-vehicle devices can be selected and performed by the user's operating the operation device. At this time, the finalizing operation can be performed with the finalizing switch regardless of running or stopped status of the vehicle. Accordingly, even while the vehicle is running, a passenger other than the driver, for example, can operate the device safely. Thus a unit to discriminate an operator and limiting the operation is unnecessary.

In this case, the operation device is positioned between adjacent seats of the vehicle. Any one of passengers on adjacent seats on both sides of the device can be similarly operate the operation device. Further, at this time, in the operation device, at least two finalizing switches are provided in left and right positions of the case body with reference to a longitudinal direction (i.e., a front-rear direction) of the vehicle. The finalizing switch can be operated from any one of left and right directions, i.e., with any one of left and right hands, without uncomfortable feeling.

Further, in the operation device, the case body has a surface shaped to have a palm rest function for stably fixing a user's hand when the hand is placed on the surface of the case body. As the operator's hand is placed on the surface of the case body and the hand is stabled in this state, the operability upon operation of the function selection switch and the finalizing switch can be further improved.

It will be obvious to those skilled in the art that various changes may be made in the above-described embodiments of the present invention. However, the scope of the present invention should be determined by the following claims.

What is claimed is:

1. An operation device for selecting a function displayed on a screen of a display device and performing the selected function, the operation device comprising:
a case body;
a function selection switch, provided on the case body, for selecting a function selection item displayed on the screen; and
at least two finalizing switches, provided in the case body, for finalize-designating the function selection item selected with the function selection switch,
wherein a same finalize-designation is made at a same timing by operating any of the at least two determination switches.

2. The operation device according to claim 1, provided in a vehicle, for performing various functions with respect to in-vehicle devices, wherein the at least two finalizing switches always realize the same function regardless of running or stopped status of the vehicle.

3. The operation device according to claim 2, positioned between adjacent seats of the vehicle.

4. The operation device according to claim 2, wherein
at least one finalizing switch of the at least two finalizing switches is provided in a left position of the case body with reference to a longitudinal direction of the vehicle and at least one finalizing switch of the at least two finalizing switches is provided in a right position of the case body with reference to the longitudinal direction of the vehicle.

5. The operation device according to claim 1, wherein the case body has a surface shaped to have a palm rest function for stably fixing a user's hand when the hand is placed on the surface of the case body.
